(19) United States
(12) Patent Application Publication
(10) Pub. No.: US 2011/0036516 A1
(43) Pub. Date: Feb. 17, 2011

(54) ROLLER SHADE

(76) Inventor: Li-Ming CHENG, Kaohsiung City (TW)

Correspondence Address: Muncy, Geissler, Olds & Lowe, PLLC, 4000 Legato Road, Suite 310, FAIRFAX, VA, 22033, US

(21) Appl. No.: 12/909,224

(22) Filed: Oct. 21, 2010

Related U.S. Application Data
(62) Division of application No. 12/121,885, filed on May 16, 2008.

(51) Int. Cl. E06B 9/60; E06B 9/56

(52) U.S. Cl. 160/311; 160/309; 160/313

(57) ABSTRACT

A roller shade includes at least an upper rail, a lower rail, a shade assembly, an automatic winding assembly and an anchor seat. The automatic winding assembly and the anchor seat are installed on two sides of the upper rail. The automatic winding assembly has a first cap assembly and a first transmission unit hinged inside to perform transmission through an elastic element. The first transmission unit further has a stub shaft at another side to wedge in one side of an axle of the shade assembly. The anchor seat is wedged in another side of the axle of the shade assembly to form rotation. Through rotation of the automatic winding assembly, retraction and extension of the shade can be controlled to facilitate operation.

### CROSS REFERENCE TO RELATED APPLICATIONS

This application is a Divisional of co-pending application Ser. No. 12/121,885, filed on 16 May 2008, and for which priority is claimed under 35 U.S.C. §120, the entire contents of which are hereby incorporated by reference.

### FIELD OF THE INVENTION

The present invention relates to a roller shade and particularly to a roller shade that has an automatic winding assembly at one side of an upper rail to control winding and extension of the shade to facilitate operation.

### BACKGROUND OF THE INVENTION

There are many different types of window shades on the market such as Venetian blinds, pleated window shades, roman shades and the like. They mainly aim to be installed at doors and windows of houses to block sunshine and serve decorative purpose. According to different user's requirements, the window shades generally have a lift cord to control rolling up or lowering of the shade. For a single panel window shade 10, a winding buffer means 11 is usually adopted (referring to FIG. 1). The winding buffer means 11 mainly includes a case, a sleeve, an external coupling member, a lid and a rotary element. To extend the shade, winding is made clockwise and the sleeve rotates idly because a spring is extended outwards, and extension of the shade can be done smoothly. To retract the shade, winding is made counterclockwise, the sleeve is latched and rotated synchronously due to tightening of the spring, hence the retraction of the shade is slower. The winding buffer means 11 thus constructed has drawbacks, notably the window shade can only be extended smoothly and retracted slowly in a given direction due to structural restriction. The buffer's direction cannot be changed according to user's desire.

### SUMMARY OF THE INVENTION

The present invention aims to provide a roller shade to resolve the aforesaid problem of the conventional window shades that cannot be anchored at a selected elevation during retraction or extension, and also take into account of safety issue. Through rotation of a transmission unit of an automatic winding assembly, the shade of the invention can be retracted and extended easily and smoothly to facilitate operation.

To achieve the foregoing object, the roller shade of the invention mainly includes an upper rail, a lower rail, a shade assembly, an automatic winding assembly and an anchor seat. The upper rail has one side coupling with the automatic winding assembly and the other side coupling with the anchor seat. The automatic winding assembly has a first cap assembly and a first transmission unit hinged inside to perform transmission through an elastic element. The first transmission unit has a stub shaft at another side to wedge in one side of an axle of the shade assembly located beneath the upper rail. The anchor seat has one side pivotally coupled with a shaft to wedge in the other side of the axle of the shade assembly. The roller shade thus formed provides many benefits, notably:
1. Through rotation of the automatic winding assembly installed on one side of the upper rail, transmission and control of retraction and extension of the shade can be accomplished to facilitate operation.
2. The roller shade is coupled with the automatic winding assembly and the anchor seat, and the automatic winding assembly can easily and smoothly control the retraction and extension operation of the shade.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional window shade with a shade winding buffer means to control retraction and extension thereof.

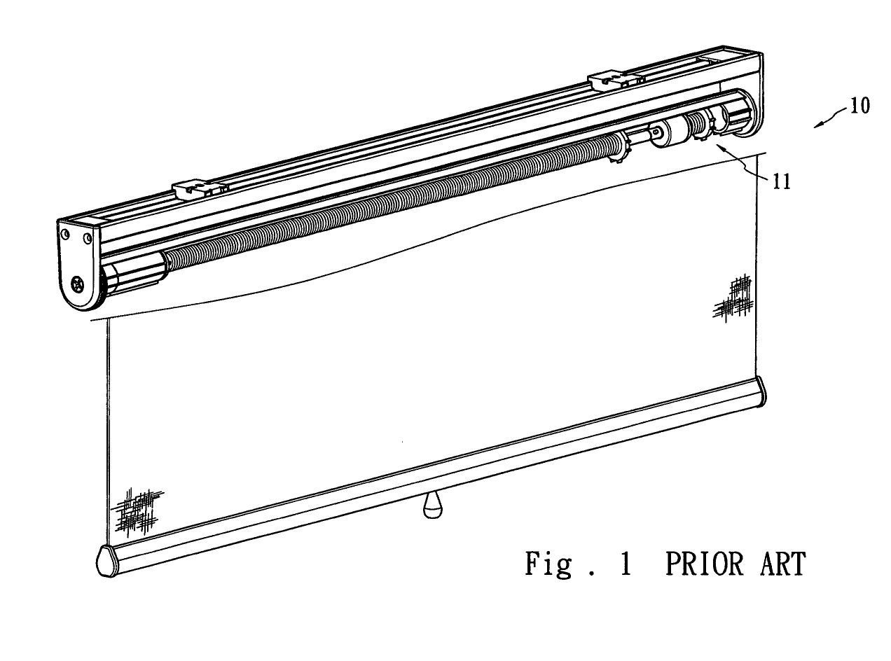

FIG. 2 is an exploded view of the invention.

FIG. 3 is an exploded view of the automatic winding assembly of the invention.

FIG. 4 is a side view of the automatic winding assembly according to FIG. 3.

FIG. 5 is an exploded view of an embodiment of the automatic winding assembly of the invention in a use condition.

FIG. 6 is an exploded view of the automatic winding assembly according to FIG. 5.

FIG. 7 is a side view of the automatic winding assembly according to FIG. 5.

FIG. 8 is an exploded view of a second embodiment of the automatic winding assembly of the invention.

FIG. 9 is a side view of the automatic winding assembly of the second embodiment.

FIG. 10 is a side view of a third embodiment of the automatic winding assembly of the invention.

FIG. 11 is a schematic view of a fourth embodiment of the automatic winding assembly of the invention in a transmission condition.

FIG. 12 is a schematic view of a fifth embodiment of the automatic winding assembly of the invention in a transmission condition for retraction.

FIG. 13 is a schematic view according to FIG. 12 in a transmission condition for extension.

FIG. 14 is a schematic view of a sixth embodiment of the automatic winding assembly of the invention in a transmission condition for retraction.

FIG. 15 is an exploded view of another embodiment according to FIG. 2.

FIG. 16 is an exploded view of the automatic winding assembly according to FIG. 15.

FIG. 17 is a schematic view of the shade assembly according to FIG. 15 moved manually (or pulled by hands).

### DETAILED DESCRIPTION OF THE PREFERRED EMBODIMENTS

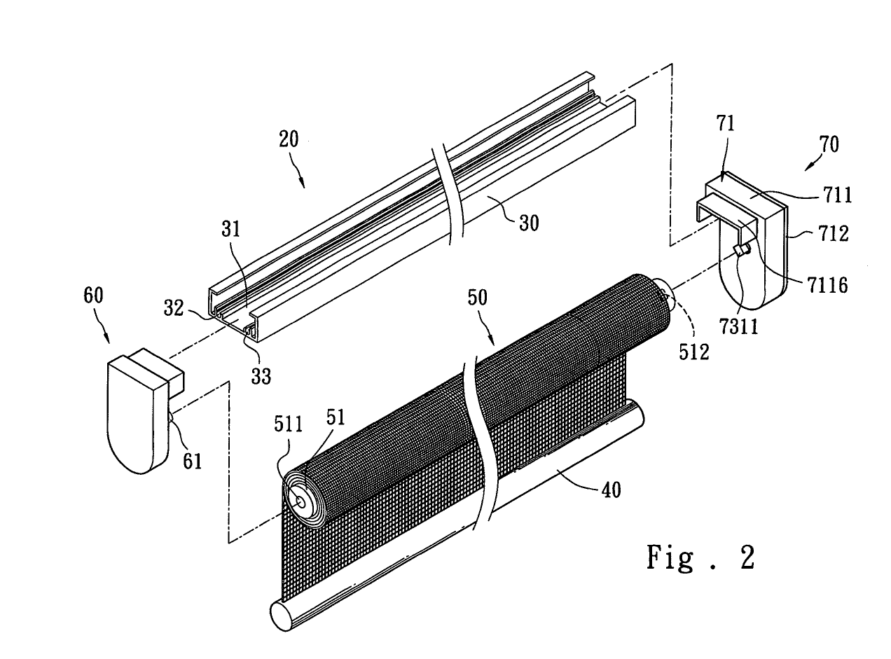

Please refer to FIG. 2, a roller shade 20 according to the invention has an elongated upper rail 30, a lower rail 40 spaced from the upper rail 30 at a lower side, a shade assembly 50 located below the upper rail 30 with an axle 51 located at one end, and an automatic winding assembly 70 located at one side of the upper rail 30. The automatic winding assembly 70 has a first transmission unit 73 coupling with the axle 51 of the shade assembly 50.

The upper rail 30 has a guiding trough 31 inside that has two sides formed respectively a fastening trough 32 and 33.

The lower rail 40 is elongated and spaced from the upper rail 30 at the lower side.

The shade assembly 50 is located between the upper rail 30 and the lower rail 40. In an embodiment shown in the drawings, it has the axle 51 at one end. The axle 51 has a second axle hole 512 at one side to be wedged in by a corresponding stub shaft 7311 of the automatic winding assembly 70, and a first axle hole 511 at other side to be wedged in by a corresponding shaft 61 of an anchor seat 60.

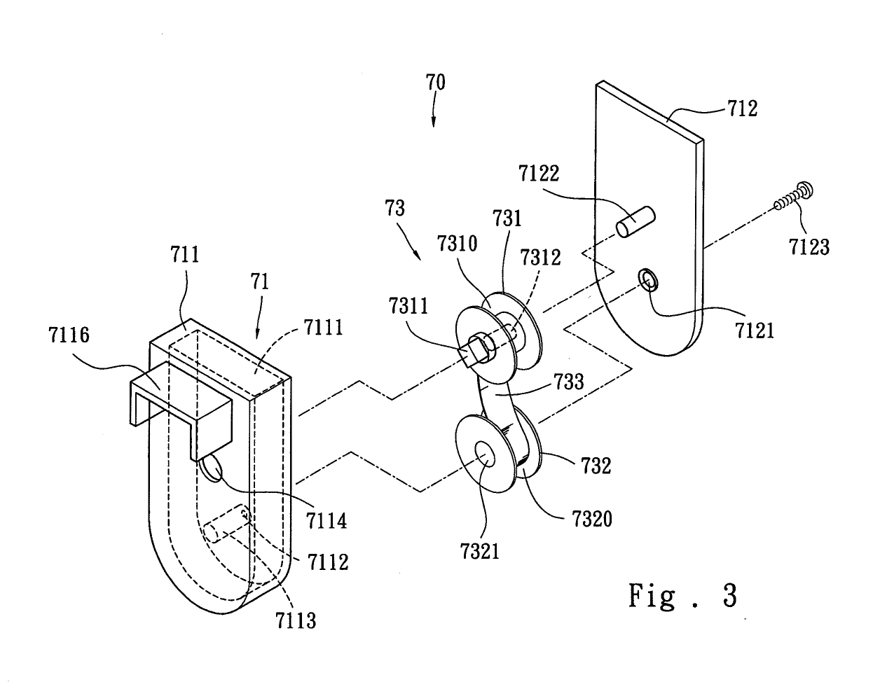

Also referring to FIGS. 2 and 3, the automatic winding assembly 70 is located at one side of the upper rail 30, and includes a first cap assembly 71 with a first transmission unit 73 hinged inside containing an elastic element 733. The first cap assembly 71 has a first cap 711 with one side thereof fastened to an outer lid 712. The first cap 711 has a housing space 7111 at one side and a first strut 7113 located at a lower side with a fastening hole 7112 formed thereon, and an opening 7114 formed at an upper side. The first cap 711 further has a first latch member 7116 extended from another side at an upper portion to wedge in one side of the guiding trough 31 of the upper rail 30. The outer lid 712 covers one side of the first cap 711 and has an aperture 7121 corresponding to the fastening hole 7112 of the first strut 7113 to receive a fastening element 7123 such as a screw to engage with the fastening hole 7112 for fastening. The outer lid 712 further has a second strut 7122 to hinge the first transmission unit 73. The first transmission unit 73 is held in the housing space 7111 at one side of the first cap 711. The first transmission unit 73 includes a first transmission wheel 731 and a second transmission wheel 732. The first transmission wheel 731 runs through by the second strut 7122 for anchoring and has a first indented annular surface 7310 formed in the middle portion with a stub shaft 7311 at one side to run through the opening 7114 of the first cap 711 and the second axle hole 512 at one side of the axle 51 to form coupling. The first transmission wheel 731 further has a first coupling hole 7312 at another side opposite to the stub shaft 7311 to be hinged by the second strut 7122. The second transmission wheel 732 is hinged on the first strut 7113 located in the housing space 7111 of the first cap 711, and has a second indented annular surface 7320 formed in the middle portion thereof with a second coupling hole 7321 formed inside running through by the first strut 7113. The elastic element 733 may be an S-shaped spring or a spring spiral torsion spring that has two ends coupling on the first transmission wheel 731 and the second transmission wheel 732 to extend or retract the shade assembly 50 below the upper rail 30. Referring to FIG. 2, the anchor seat 60 is located at another side of the upper rail 30 and has the shaft 61 at one side to wedge in the first axle hole 511 of the axle 51.

When the roller shade 20 is in use, the automatic winding assembly 70 and the anchor seat 60 are coupled on two sides of the upper rail 30. Through rotation of the first transmission unit 73 of the automatic winding assembly 70, the shade assembly 50 can be retracted and extended as desired. Operation is simple and easy.

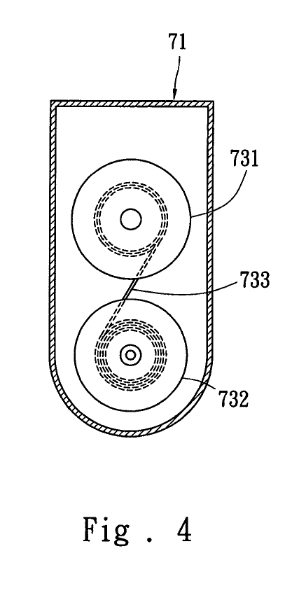

Referring to FIGS. 2, 3 and 4, during retraction and extension of the shade assembly 50, the lower rail 40 may be pushed (or pulled) by a user's hand like a gravity balancing bar. By incorporating with the extension or retraction of the elastic element 733 in the first cap 711 of the automatic winding assembly 70, the shade assembly 50 can be moved upwards in a retraction condition or lowered in an extension condition. When the shade assembly 50 reaches a desired elevation, the lower rail 40 which serves as the gravity balancing bar can keep the shade assembly 50 at the desired elevation without moving upwards or downwards. Thus operation of the shade assembly 20 can be controlled effectively.

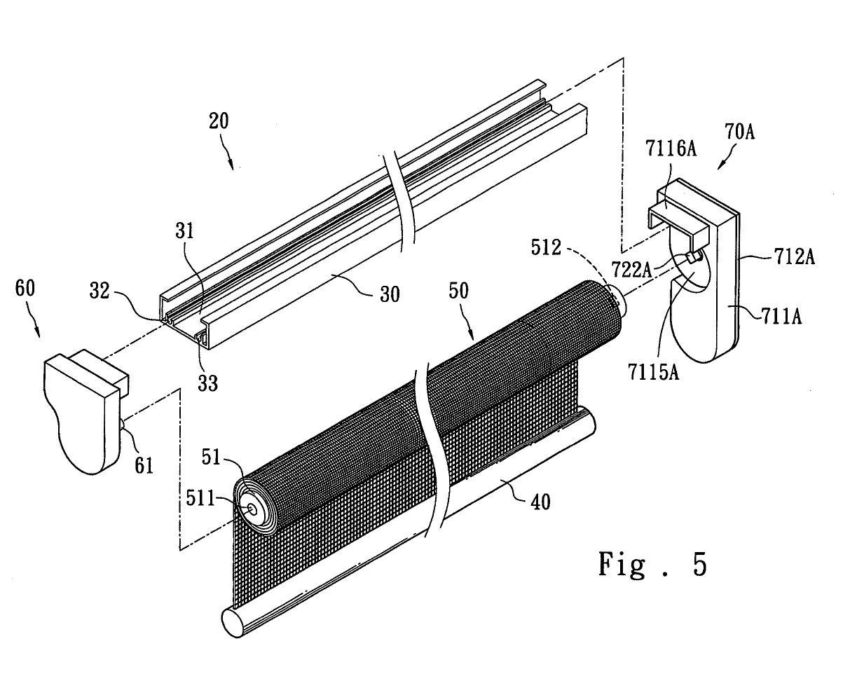

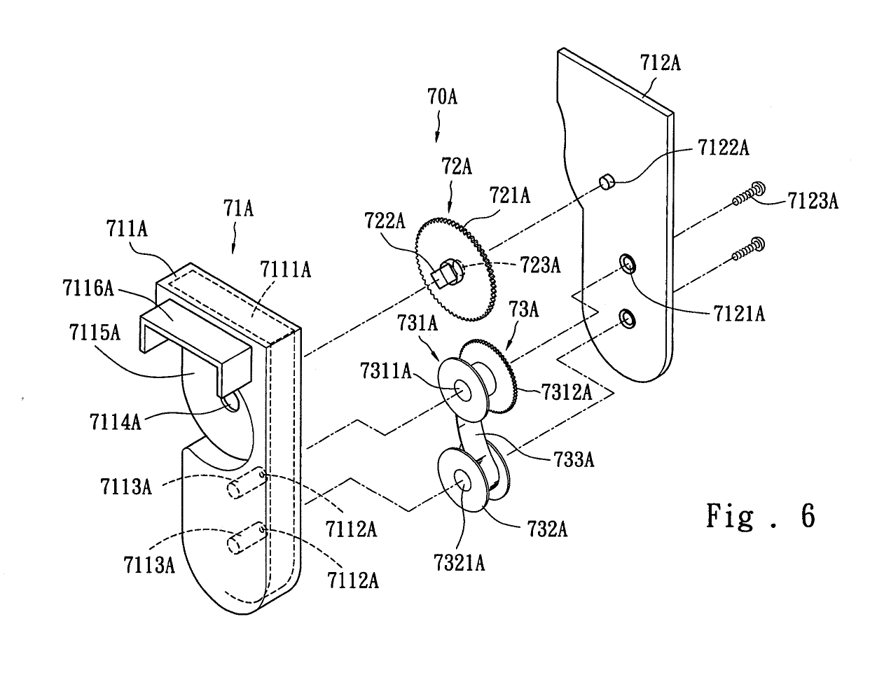

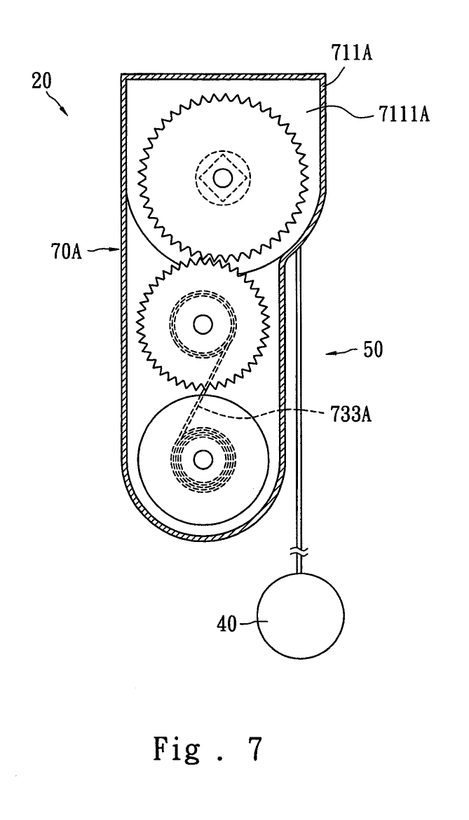

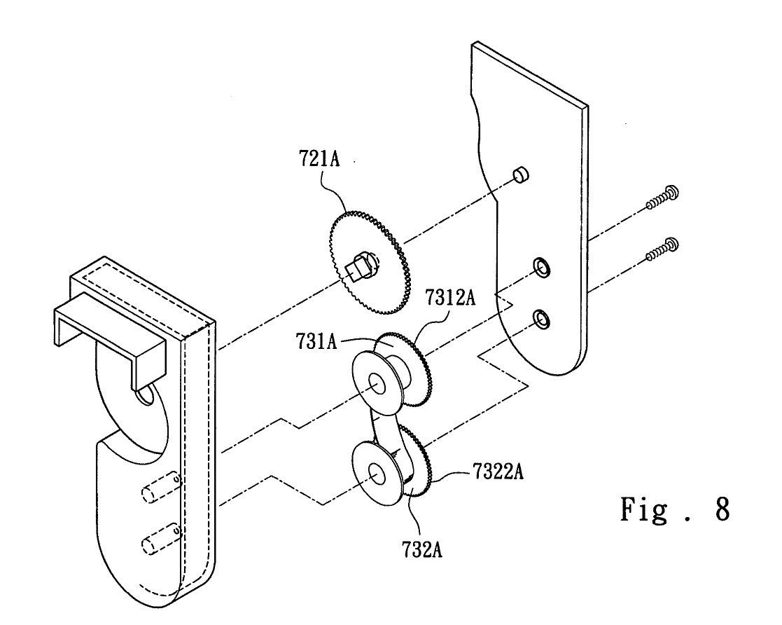

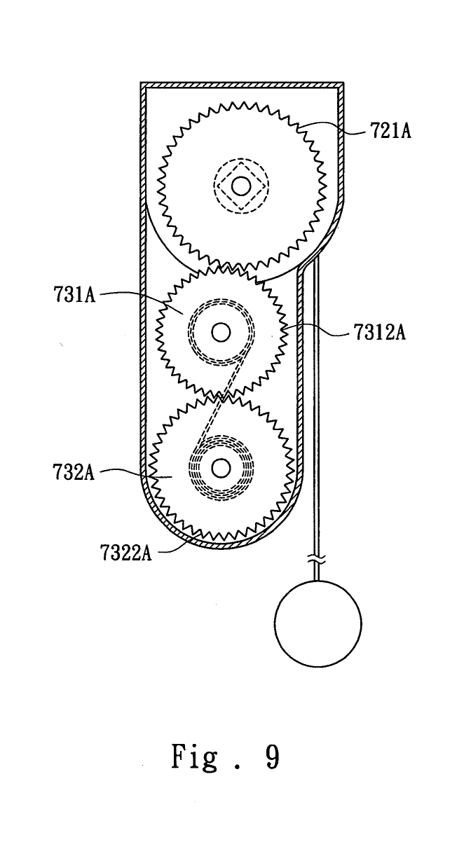

Refer to FIGS. 5, 6 and 7 for a second embodiment of the automatic winding assembly 70A. The automatic winding assembly 70A also is located at one side of the upper rail 30, and includes a first cap assembly 71A with a first transmission unit 73A hinged inside containing an elastic element 733A and a second transmission unit 72A. The first cap assembly 71A has a first cap 711A with one side thereof fastened to an outer lid 712A. The first cap 711A has a housing space 7111A at one side and a first strut 7113A located at a lower side with a fastening hole 7112A formed thereon. The first cap 711A further has a first latch member 7116A extended from another side at an upper portion to wedge in one side of the guiding trough 31 of the upper rail 30, and a holding compartment 7115A at a lower side to hold the axle 51 at one end of the shade assembly 50. There is an opening 7114A at one end of the holding compartment 7115A. An outer lid 712A covers one side of the first cap 711A and has an aperture 7121A corresponding to the fastening hole 7112A of the first strut 7113A to receive a fastening element 7123A such as a screw to engage with the fastening hole 7112A for fastening. The outer lid 712A further has a second strut 7122A at an upper side corresponding to the opening 7114A of the first cap 711A. The second transmission unit 72A is located at an upper side of the housing space 7111A of the first cap 711A, and runs through by the second strut 7122A of the outer lid 712A to be anchored. It has a second gear 721A formed on the perimeter and a stub shaft 722A at one side to run through the opening 7114A of the first cap 711A and the second axle hole 512 of the axle 51 to form wedging, and a corresponding coupling hole 723A formed at the other side opposite to the stub shaft 722A to hinge the second strut 7122A. The first transmission unit 73A is hinged on the first strut 7113A at the lower side of the housing space 7111A, and includes at least a first transmission wheel 731A and a second transmission wheel 732A that correspond to each other, and an elastic element 733A coupling with the first and second transmission wheels 731A and 732A. The first transmission wheel 731A has a through hole 7311A and a first gear 7312A formed on the perimeter engaging with the second gear 721A of the second transmission unit 72A. The second transmission wheel 732A is located at a lower side corresponding to the first transmission wheel 731A, and has a through hole 7321A in the center. Referring to FIGS. 8 and 9, there is a third gear 7322A on the perimeter of the second transmission wheel 732A to engage with the first gear 7312A to form chain movement therewith. The elastic element 733A may be an S-shaped spring with one end latched on the first transmission wheel 731A and the other end latched on the second transmission wheel 732A, so that the shade assembly 50 located below the upper rail 30 can be extended or retracted by the elastic element 733A.

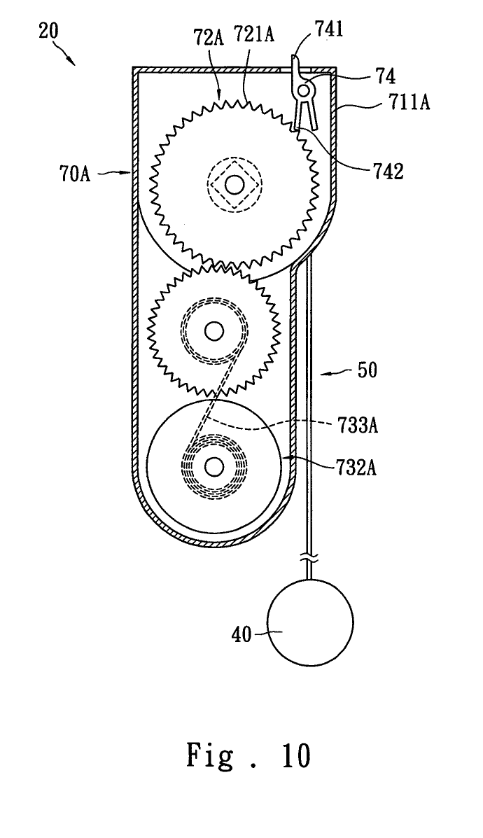

Referring to FIG. 10, the automatic winding assembly 70A further has a latch element 74 located at one side of the first cap 711A that has a push element 741 at one end extending above the first cap 711A and a pawl 742 at the other end to latch on the second gear 721A of the second transmission unit 72A, so that the retracting shade assembly 50 can be anchored to facilitate packaging and installation of the roller shade 20. After installation is finished, move the push element 741 away, the pawl 742 can be separated from the second gear 721A. Then by means of extension or retraction of the S-shaped elastic element 733A between the first transmission wheel 731A and second transmission wheel 732A, the shade assembly 50 can be moved upwards in a retraction condition or lowered in an extension condition.

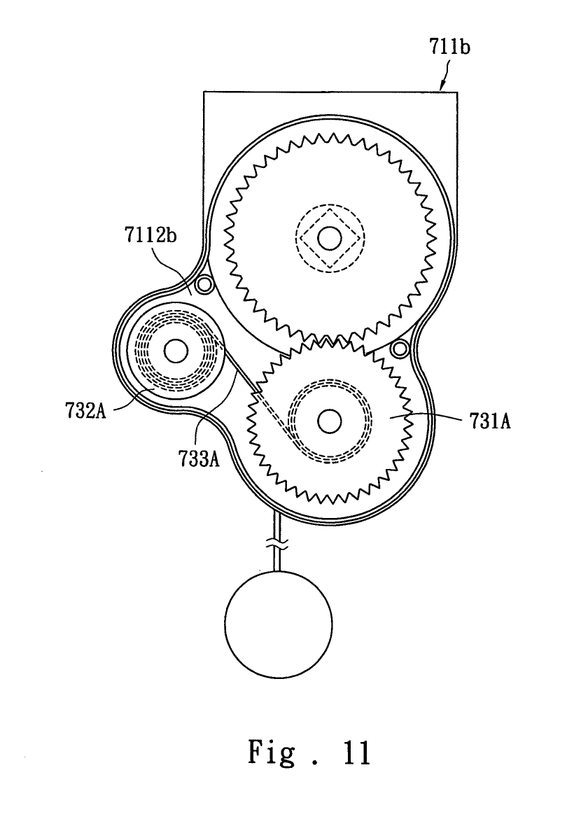

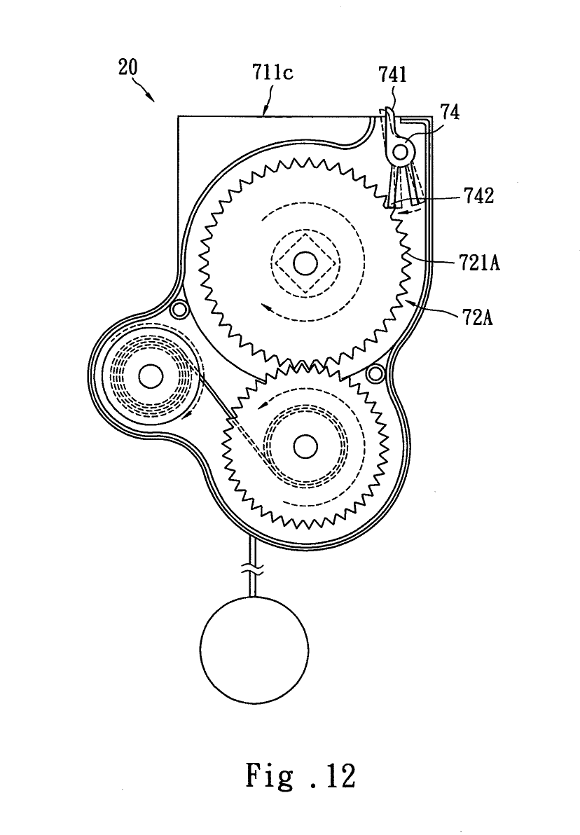

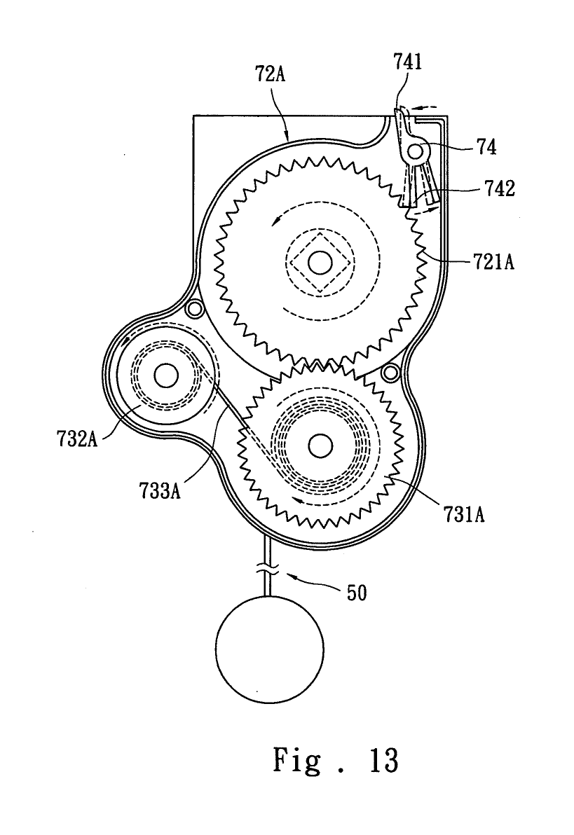

Referring to FIG. 11, the first cap 711b has a holding portion 7112b at one side or the other side to hold the second transmission wheel 732A on the left side or right side of the first transmission wheel 731A. By means of the elastic element 733A interposed between the first and second transmission wheels 731A and 732A, coupling and transmission can be accomplished. Referring to FIG. 12, the latch element 74 may also be located at an upper side of the first cap 711c and has the push end 741 extended above a first cap 711c and the pawl 742 at the other end to latch the second gear 721A of the second transmission unit 72A to anchor the roller shade 20. Referring to FIG. 13, when the push element 741 is pushed away the pawl 742 can be separated from the second gear 721A. Through extension or retraction of the S-shaped elastic element 733A between the first and second transmission wheels 731A and 732A, the shade assembly 50 can be moved upwards in the retraction condition or lowered in the extension condition.

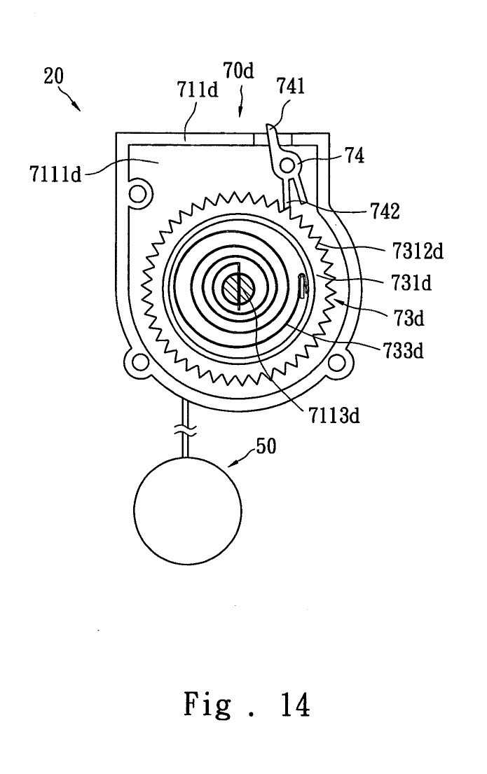

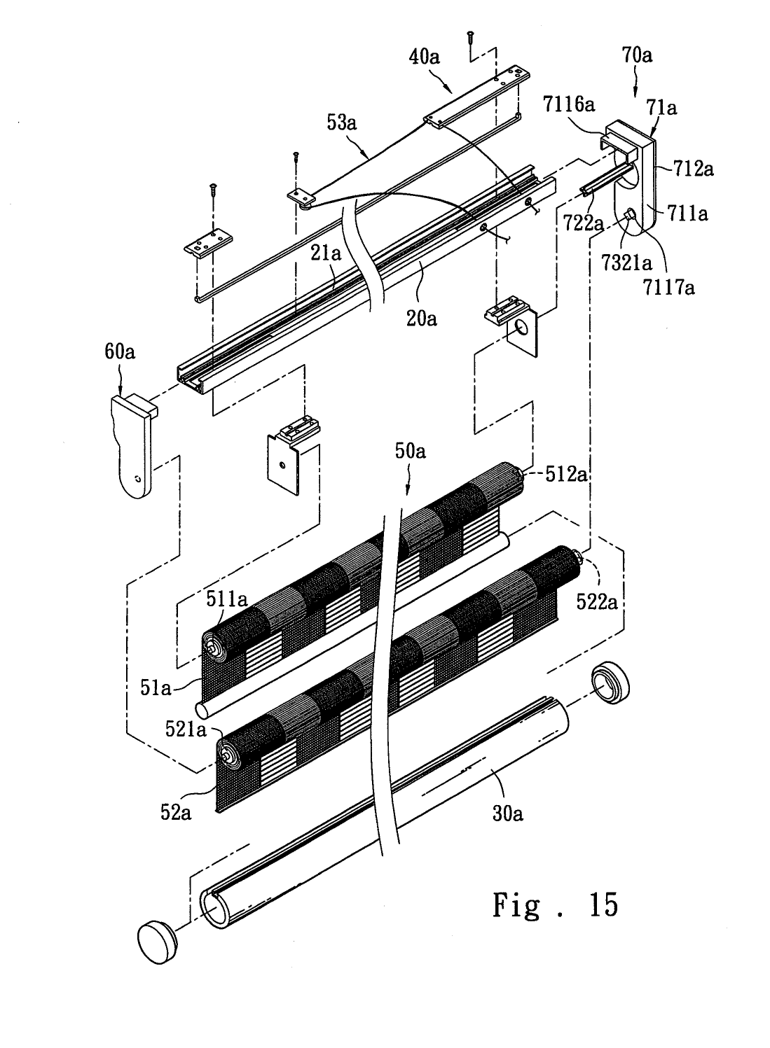

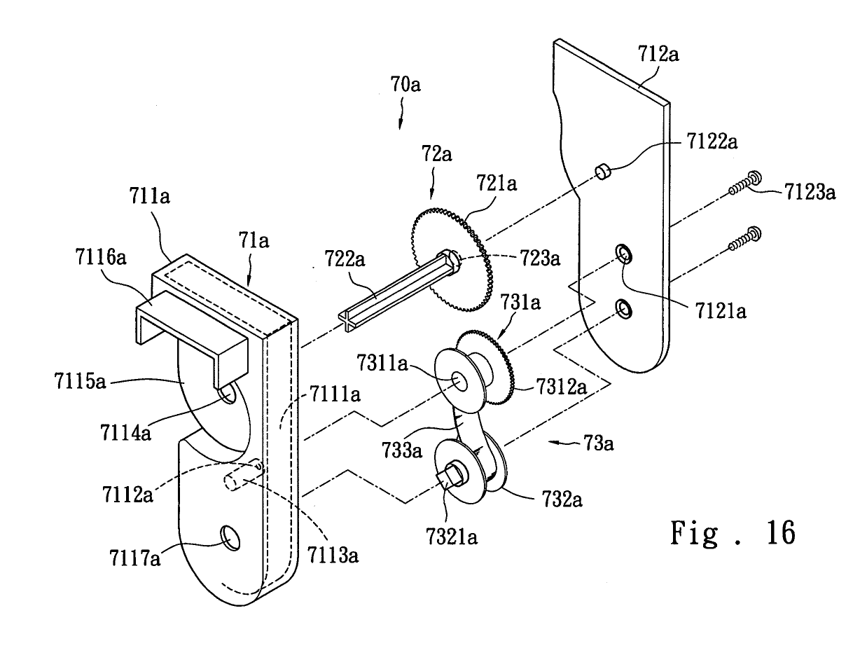

Referring to FIG. 14, the automatic winding assembly 70d includes a first cap 711d with a housing space 7111d at one side to hinge a first transmission unit 73d. The first transmission unit 73d has a first transmission wheel 731d and an elastic element 733d. The first transmission wheel 731d has a stub shaft (not shown in the drawing) to wedge in the second axle hole (not shown in the drawing) at one side of the axle 51 of the shade assembly 50. The elastic element 733d has one end latched on the first transmission wheel 731d and the other end latched on a first strut 7113d hinged on the first transmission wheel 731d. In this embodiment, the elastic element 733d is a spiral torsion spring spring. There is a latch element 74 located at an upper side of the first cap 711d. The latch element 74 has a push element 741 extended above the first cap 711d and a pawl 742 at the other end to latch on a first gear 7312d formed on the perimeter of the first transmission wheel 731d to anchor the roller shade 20. Referring to FIGS. 15 and 16, the invention may also be adopted on a double-layer window shade. It includes a hollow and elongated upper rail 20a with a guiding trough 21a formed inside, a lower rail 30a spaced from the upper rail 20a at a lower side, a transverse moving means 40a located in the upper rail 20a, a panel lift cord assembly 50a which has a first panel 51a, a second panel 52a and a lift cord assembly 53a, an anchor seat 60a located at one side of the upper rail 20a and an automatic winding assembly 70a located at the other side thereof. The automatic winding assembly 70a includes a first cap assembly 71a with a second transmission unit 72a located inside engaging with a first transmission unit 73a which has an elastic element 733a. The first cap assembly 71a has a first cap 711a with one side fastened to an outer lid 712a. The first cap 711a has a housing space 7111a at one side and a first strut 7113a located at a lower side with a fastening hole 7112a formed thereon and an aperture 7117a, and a housing space 7115a at an upper portion of the other side to hold an axle 511a at one end of the panel lift cord assembly 50a. The housing space 7115a has one end with an opening 7114a formed thereon. The first cap 711a further has a first latch member 7116a extended from the other side at an upper portion to wedge in one side of the guiding trough 21a of the upper rail 20a. The outer lid 712a covers one side of the first cap 711a and has an aperture 7121a corresponding to the fastening hole 7112a of the first strut 7113a to receive a fastening element 7123a such as a screw to engage with the fastening hole 7112a for fastening. The outer lid 712a further has a second strut 7122a corresponding to the opening 7114a. The second transmission unit 72a is located at the upper side of the housing space 7111a of the first cap 711a and runs through by the second strut 7122a of the outer lid 712a for anchoring. The second transmission unit 72a has a second gear 721a formed on the perimeter and an elongated shaft 722a at one side to run through the opening 7114a of the first cap 711a and the second axle hole 512a at one side of the first axle 511a to form wedged coupling. There is a coupling hole 723a at one side opposite to the elongated shaft 722a to be wedged in by the second strut 7122a. The first transmission unit 73a includes a first transmission wheel 731a, a second transmission wheel 732a and an elastic element 733a. The first transmission wheel 731a has a through hole 7311a run through by the first strut 7113a, and a second gear 721a formed on the perimeter to engage with the first gear 7312a. The second transmission wheel 732a is located at a lower side of the first transmission wheel 731a and has a stub shaft 7321a at one side running through an aperture 7117a to wedge in a second axle hole 522a at one side of the second axle 521a coupling with a panel lift cord assembly 50a. The elastic element 733a may be an S-shaped spring with one end latched on the first transmission wheel 731a and the other end latched on the second transmission wheel 732a. The panel lift cord assembly 50a is wound below the upper rail 20a and extended or retracted by the elastic element 733a.

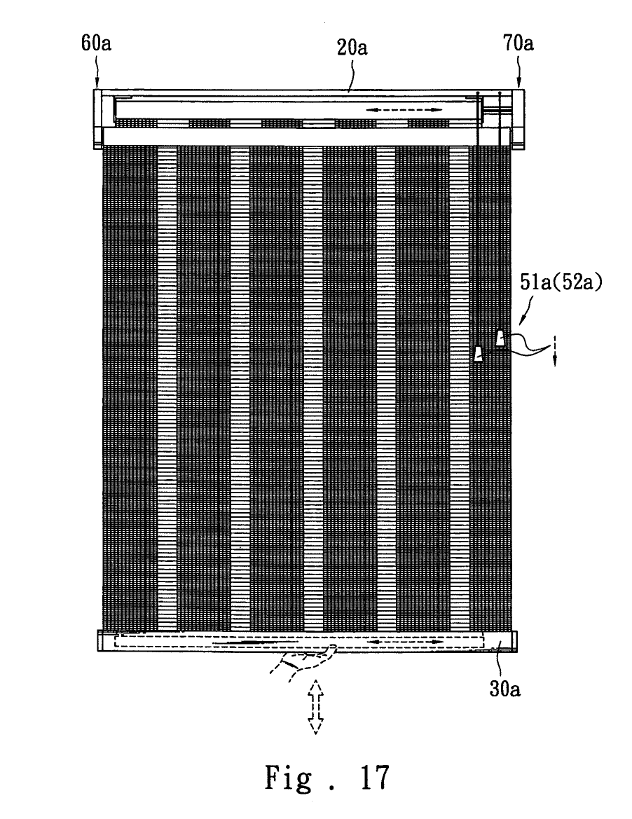

Referring to FIGS. 15 and 16, when in use, the lower rail 30a is moved by a user's hand, the first transmission unit 73a and the second transmission unit 72a both hinged in the housing space 7111a of the first cap 711a are driven in a transmission condition by the first and second panels 51a and 52a respectively. The second gear 721a also drives the first gear 7312a to rotate at the same time. The second transmission wheel 732a coupled with the elastic element 733a also is driven to rotate. The elongated shaft 722a of the second transmission unit 72a and the stub shaft 7321a are coupled to move the first and second panels 51a and 52a in an upward retracting condition or downward extending condition (referring to FIGS. 15 and 17). Meanwhile the engaging second gear 721a and first gear 7312a drive the first and second panels 51a and 52a upwards in the retracting condition or downwards in the extending condition at the same time. The engaging gears may also be replaced by equivalent means such as a belt-pulley set or chain-sprocket set to achieve the same effect. Thus by means of the automatic winding assembly 70a previously discussed, the first and second panels 51a and 52a of the double-layer window shade can be retracted and extended smoothly as desired. Operation is simple and easy.

What is claimed is:

1. A roller shade, comprising:
an elongated upper rail;
a shade assembly which is located below the upper rail and has an axle at one end thereof; and
an automatic winding assembly which is located at one side of the upper rail and coupled with the axle of the shade assembly and has a first transmission unit.

2. The roller shade of claim 1, wherein the first transmission unit includes an elastic element.

3. The roller shade of claim 2, wherein the elastic element is an S-shaped spring.

4. The roller shade of claim 3, wherein the first transmission unit includes a first transmission wheel and a second transmission wheel, the S-shaped spring having two ends coupling with the first transmission wheel and the second transmission wheel.

5. The roller shade of claim 2, wherein the automatic winding assembly has a second transmission unit.

6. The roller shade of claim 5, wherein the first transmission unit has a first transmission wheel which has a first gear formed on the perimeter thereof, the second transmission unit having a second gear formed on the perimeter thereof engaging with the first gear.

7. The roller shade of claim 5, wherein the second transmission unit has a stub shaft located at one side wedging with the axle of the shade assembly.

8. The roller shade of claim 6, wherein the automatic winding assembly further has a latch element which has a push element at one end and a pawl at the other end to engage with the second gear.

9. The roller shade of claim 5, wherein the automatic winding assembly further has a latch element which has a push element at one end and a pawl at the other end to engage with the second gear.
